(19) United States
(12) Patent Application Publication
(10) Pub. No.: US 2022/0009182 A1
(43) Pub. Date: Jan. 13, 2022

(54) A DETECTION SYSTEM, A METHOD AND A DETECTION DEVICE THEREOF

(71) Applicant: LM WIND POWER A/S, Kolding (DK)

(72) Inventors: Poul JAKOBSEN, Kolding (DK); Maria DE LOURDES MACIAS ARIAS, Kolding (DK)

(21) Appl. No.: 17/292,670

(22) PCT Filed: Nov. 11, 2019
(86) PCT No.: PCT/EP2019/080858

§ 371 Date: May 10, 2021

(30) Foreign Application Priority Data
Nov. 13, 2018 (EP) 18205896.6

(51) Int. Cl. B29C 70/54; B29C 70/30

(52) U.S. Cl. CPC B29C 70/54; F03D 1/0675; F05B 2230/20; B29C 70/30

(57) ABSTRACT

This invention relates to a detection system, a detection device thereof and a method, comprising a support structure having a contact surface for contacting a first surface of a moulding element having a composite structure, wherein a number of detectable element is arranged below the contact surface and configured to interact with the detection device via a magnetic field. The detection device is moved along a second surface of the moulding element and is configured to detect a position on the second surface of a reference line in relation to a detectable element, wherein the reference line is formed by the detectable elements.

### TECHNICAL FIELD

The present invention relates to a detection system comprises a support structure configured to hold a moulded object, wherein a number of detectable elements is arranged below a contact surface of the support structure.

The present invention further relates to a method of manufacturing a wind turbine blade, and a detection device thereof.

### BACKGROUND

It is known to manufacture wind turbine blades in two or more blade parts, which are then joined together to form the wind turbine blade. A first blade shell part may be moulded in a first blade mould, and a second blade shell part may be moulded in a second blade mould. Each blade mould has a moulding surface shaped to form either the pressure or suction side of the airfoil profile of the wind turbine blade. Outer layers of a fibre material may be laid up along the moulding surface. Optionally, a protective coating may be applied to the moulding surface before the lay-up. A core material may subsequently be positioned on the outer layers. Inner layers of a fibre material may then be laid up over the core elements and the outer layers to form a sandwich structure. Resin may subsequently be introduced into the sandwich structure, e.g. using a vacuum assisted resin infusion process. The resin may then be cured to form the first blade shell part. The process may be repeated for the second blade shell part.

A load carrying structure is integrated into or attached to one or both blade shell parts. For example, at least one main laminate is integrated into or attached to each of the first and second blade shell parts. Further, at least one main shear web is integrated into or attached to the main laminate(s) in each blade shell part. Optionally, another reinforcing web may further be integrated into or attached to the first and second blade shell parts, e.g. to another main laminate thereof, towards the trailing edge and/or the leading edge.

These webs must be correctly aligned within the blade shell parts during assembly to transfer shear forces. It is known to use arches to accurately position the shear webs, however, such arches become too large and heavy to handle for large wind turbine blades.

U.S. Pat. No. 9,932,958 B2 discloses a method of aligning the shear webs wherein the shear webs are pre-loaded into a plurality of jigs and interconnected using spacer elements. Further, a plurality of engaging markers is aligned along the length of the blade shell using a positioning tool abutting the leading or trailing edge of the wind turbine blade. The shear web arrangement is then lifted into position above the blade shell and lowered until the spacer elements and the markers are brought into engagement. The markers must be accurately positioned for the spacer elements to be brought into engagement, any misalignment would require re-positioning of the markers.

WO 2017/088890 A1 discloses the use of laser beams to project two sets of reference lines and distinctive mounting points onto the inner surface of the blade shell part. A plurality of web guiding brackets is then positioned and attached to the blade shell part using these reference lines and mounting points. The shear webs are subsequently lifted into position and guided into alignment by means of these brackets. This solution requires multiple lasers in order to mark the individual reference lines and mounting points, and a large power unit to power these lasers.

It is further known to use magnets to secure the fibre layers relative to the moulding surface in order to prevent the layers from sliding out of position during lay-up and/or resin infusion. For example, EP 2783840 A1 discloses magnets arranged below the moulding surface of the blade mould, wherein the magnets are configured to interact with clamping devices arranged on the moulding flanges of the blade mould. The magnetic force is selected to hold the fibre layers in position during the lay-up. For example, EP 2326475 B1, discloses electromagnets arranged below the moulding surface and configured to interact with a magnetic conductive material in the laminate of fibre layers. In this solution, the magnets are mounted independently of any longitudinal reference lines of the wind turbine blade.

### OBJECT OF THE INVENTION

An object of the invention is to provide a detection system, a method and a detection device that overcomes the abovementioned problems.

Another objection of the invention is to provide a detection system, a method and a detection device that provides a cheap and simple way of determining the relative positions of the webs and other items placed on the blade shell.

A further objection of the invention is to provide a detection system, a method and a detection device that reduces the amount of manual labour associated with guiding the shear webs into alignment.

A further objection of the invention is to provide a detection system, a method and a detection device that saves production costs and moulding time.

### DETAILED DESCRIPTION OF THE INVENTION

One object of the invention is achieved by a detection system for detecting a reference parameter of a moulding element, such as a composite structure, the detection system comprising a support structure configured to hold the moulding element, the support structure having a contact surface shaped to contact a first surface of the moulding element, the detection system, e.g. the support structure of the detection system, comprising at least one detectable element arranged relative to the contact surface, e.g. such that the first surface of the moulding element when being in contact with the contact surface faces towards the detectable element, the at least one detectable element being configured to interact with at least one detection device via a magnetic field, e.g. through the moulding element, characterised in that said at least one detectable element forms at least one reference parameter of said moulding element, and that said at least one detection device is configured to be moved relative to said contact surface, e.g. along said contact surface, and to detect a position of said at least one reference parameter on a second surface, e.g. opposite the first surface, of the moulding element in relation to said at least one detectable element.

The magnet field may be generated by the detectable element where the local magnetic field lines extend through the contact surface, which may then be detected by the detection device. Alternatively, the detection device may generate a magnet field and be able to detect when the detectable element is located within that magnetic field.

Here, the term “moulding element” should be understood as an element that is manufactured in a moulding process, this moulding element may form part of a larger component. Further, the term “reference parameter” should be understood as any reference parameter used during the moulding process and/or the assembly of the larger component.

Preferably, the moulding element is a composite structure comprising a laminate of layers of a fibre material and/or a core material sandwiched between layers of a fibre material. The fibre material is infused with resin and subsequently cured.

The support structure comprises a frame body configured to provide support for a contacting body part, wherein said body part has a contact surface shaped to contact a first surface of the moulding element. The contact surface extends from a first edge to a second edge in a chordwise direction and further from a first end to a second end in a longitudinal direction.

The present invention provides a simple and cheap way of detecting, and subsequently marking, any relevant reference parameters used during moulding of the element and/or during assembly of the larger component. The present invention eliminates the need for a laser-based system placed overhead, or engaging markers placed on the second surface of the moulding element. Further, it may also reduce the amount of manual labour associated with correctly aligning mounting or guiding elements on the moulding element.

According to one embodiment, said at least one reference parameter is a reference line, a reference point and/or a mounting point.

The moulding process and/or the assembly process may involve marking one or more reference parameters on the second surface of the moulding element. Such reference parameters may include, but not limited to, reference lines, reference points, mounting points, and other reference features.

The detectable elements may be placed at predetermined positions relative to the contact surface corresponding to these reference parameters. The position of each detectable element may then be detected on the second surface using the detection device and subsequently marked. This allows for an easy detection of the reference parameters within the use of projecting laser beams. Conventional laser systems must have a sufficient high intensity so that the surrounding light sources do not affect the laser beams projected onto the second surface.

According to one embodiment, a first number of detectable elements are distributed along the contact surface to form a first reference line, and at least a second number of detectable elements are further distributed along the contact surface to form at least a second reference line, the second reference line being arranged at a distance from said first reference line.

The support structure may simply comprise a single row of detectable elements distributed along the contact surface in the longitudinal direction and/or in the chordwise direction. This row of detectable elements may be arranged to form a main reference line, e.g. a centreline, of the moulding element. This main reference line may then be used to mark additional reference lines, if needed, using the detection device.

The support structure may instead comprise a number of rows of detectable elements distributed along the contact surface, each row forms a reference line of moulding element. Any one of these reference lines may then detected using the detection device.

Additionally or alternatively, the support structure may comprise a number of individual detectable elements each placed at a distinctive position. These detectable elements may each form a reference point and/or a mounting point, which can be detected using the detection device.

Preferably, the distance of the first and second reference lines changes at least partly in the longitudinal direction and/or in the chordwise direction. For example, the distance may decrease from the first end towards the second end, or vice versa. For example, the distance may decrease from the first edge towards the second edge, or vice versa.

The distance may thus be adapted to the chordwise profile of the moulding element. Alternatively, the first and second reference lines may be spaced apart with a constant distance. This is relevant for alignment of webs and/or spacer elements in a wind turbine blade.

The at least one detectable element may be below the contact surface. According to one embodiment, said at least one detectable element is integrated into the support structure. Alternatively, the at least one detectable element may be arranged on a surface of the support structure opposite the contact surface.

One or more of the detectable elements may be arranged flushed with the contact surface to form a continuous contact surface. Alternatively, one or more of the detectable elements may be arranged at a distance from the contact surface, such as below the contact surface. The placement of each detectable element may thus be adapted to the geometric profile of contact surface, the local thickness of the moulding element, and/or the materials of the moulding elements.

For example, the detectable element may be integrated into the supporting frame body and/or the contacting body part. The detectable element may be placed in a recess in the contact surface or embedded in the contacting body part. The detectable element may thus be concealed with the support structure.

According to one embodiment, the least one detectable element is arranged on a holding element, the holding element being configured to be connected to the support structure, such as to a surface of the support structure opposite the contact surface.

The detectable element may instead be arranged on a holding element configured to be connected to the support structure, such as to a surface of the support structure opposite the contact surface. The holding element may be shaped as a bracket for mounting the detectable element. The holding element may be arranged relative to a bottom surface of the contacting body part. This for easy mounting of the detectable elements. This also enables existing support structures to be retrofitted with detectable elements.

The detectable element may be mounted in a fixed or permanent position relative to the contact surface.

According to one embodiment, said holding element comprises adjustable means for adjusting the position of that detectable element in the chordwise direction and/or in the longitudinal direction.

The holding element may further comprise an adjustable mechanism for adjusting the position of the detectable element relative to the contact surface. The adjustable mechanism may simple be one or more bolts connected to a moveable seat for the detectable element. The adjustable mechanism may also be a row of holes or an elongated hole in which the positioning of a bolt or a clamp can be adjusted. Other adjustable mechanism may also be used.

According to one embodiment, said at least one detection device further comprises alignment means for aligning the at least one detection device relative to the position of the at least one detectable element.

Here, the term “alignment” should be understood as the orientation of the detection device being correctly aligned with the orientation of the detectable element. For example, the detection device should be aligned parallel with the reference line.

The alignment means may simply be a display on the detection device where the detected profile of detectable element can be aligned with an alignment window on the display.

Alternatively, the detection device may be configured to detect two or more detectable elements within the same row, e.g. adjacent detectable elements, in order to correctly align the detection device.

According to one embodiment, said at least one detection device further comprises a template extending from the detection device, wherein said template comprises means for marking at least one selected reference parameter.

A template for marking at least one selected reference parameter may be integrated or mounted to the detection device. The template may comprise a set of individual marking means, e.g. holes, for marking different reference parameters. The position of a reference parameter may then be selected and marked using said marking means. The template may extend in opposite directions from the detection device. Alternatively, a first template may extend in one direction from the detection device while a second template may extend in an opposite direction. Preferably, the template is used for marking two or more reference parameters at the same time, thus saving time during production.

The detection device may simply comprise a single marking means for marking the position of a dedicated reference parameter. Preferably, the template is used for marking a number of dedicated reference parameters, such as a set of reference lines and/or mounting points.

According to one embodiment, said at least one detection device comprises an arrangement of sensors configured to detect said at least one detectable element, the sensors being connected to a control unit and/or a display unit for determining the position of the at least one detection device in relation to the at least one detectable element.

The detection sensor may comprise a sensor arrangement comprising a number of sensors arranged relative to each other. Each sensor may be configured to detect the magnetic field of the detectable element. The sensors may be connected to a control unit configured to process each sensor signal and generate an output signal for each sensor indicative of whether the detectable element is detected or not. The output signal may then be displayed on a display unit connected to the control unit. Different colours may be used to display whether the detection device is correctly aligned or not.

The sensor arrangement may also be configured to detect the presence of the detectable element within a detection window. The control unit may then process this sensor signal to generate an output signal indicative of a detected image of the detectable element. This output signal may be displayed on the display unit so that operator is able to correctly align the detection device.

Said sensors may be a magnetic sensor, such as a microelectromechanical systems (MEMS) device, a Gauss sensor, a Hall sensor, or another suitable sensor.

The detection device further comprises a suitable power unit, e.g. a battery, for powering the electrical components.

According to one embodiment, said at least one detectable element is a permanent magnet, an electromagnet or a magnetisable element.

The detectable element may be a permanent magnet, an electromagnetic device, a magnetisable element, or another suitable detectable element. The magnetic field strength may be selected dependent on the material of the contacting body part, the local thickness of the moulding element, and/or the materials of the moulding element.

The detectable element may have a unique shape which can be detected by the detection device. Said unique shape may indicate a dedicated reference parameter, such as a reference line or a mounting point. Alternatively, the detectable element may extend at least a part of the length of the contact surface, thus forming a continuous detectable element, e.g. an electrical wire.

According to one embodiment, said moulding element is a composite structure of a wind turbine blade, and said support structure is a mould for moulding said composite structure or a cradle for holding said composite structure.

The present invention is particularly suited for manufacture of composite structures, such as wind turbine blades. The support structure may be a blade mould in which a composite structure may be moulded. The support structure may also be a cradle for receiving and holding the composite structure in a post-moulding process.

The moulding element may be a blade shell part, wherein at least one main laminate is either integrated or attached to the blade shell part.

In this configuration, the detectable elements may form reference lines indicating the locations of one or more webs on the second surface. Alternatively or additionally, the detectable element may form reference lines indicating the locations of one or more local spacer elements or bulkheads. Alternatively or additionally, the detectable element may form mounting points for attachment of guiding elements used to guide the webs and/or spacer elements into alignment.

One objection of the invention is also achieved by a detection device of a detection system, the detection system comprises a support structure configured to hold a moulding element having a composite structure, such as a wind turbine blade or wind turbine blade shell part, the support structure having a contact surface shaped to contact a first surface of the moulding element, the moulding element further having a second surface opposite of said first surface, the detection system, such as the support structure of the detection system, further having at least one detectable element arranged relative to said contact surface, e.g. such that the first surface of the moulding element when being in contact with the contact surface faces towards the detectable element, and configured to interact with the detection device via a magnetic field, e.g. through the moulding element, wherein said detection device is configured to be moved relative to said contact surface, e.g. along said contact surface, and to detect a position of at least one reference parameter on the second surface in relation to said at least one detectable element, the at least one reference parameter being formed by said at least one detectable element.

This allows for a simple and easy detection of the positions of various reference parameters without the use of a laser-based system. The present detection device comprises a sensor arrangement capable of interacting with the detectable elements via a magnetic field.

The detection device may advantageously be configured as a handheld scanner or provided on a hockey stick, thus allowing the operator to move the detection device along the second surface. The positions of the reference parameters may then be marked using a template of the detection device. The template may be interchanged with another template, or be adapted to the configuration of the moulding element.

One objection of the invention is further achieved by a method of detecting a reference line of a moulding element, the method comprises the steps of:
providing a support structure configured to hold the moulding element, the support structure having a contact surface shaped to contact a first surface of the moulding element, the support structure comprising at least one detectable element arranged relative to the contact surface, e.g. such that the first surface of the moulding element when being in contact with the contact surface faces towards the detectable element, e.g. arranged below the contact surface or embedded in the contact surface as described above, and configured to interact with a detection device via a magnetic field, e.g. through the moulding element,
providing the moulding element having a composite structure, such as a wind turbine blade or a wind turbine blade shell part, the moulding element further has a second surface opposite of said first surface, and
moving the detection device along said second surface to detect a position of at least one reference parameter on the second surface in relation to said at least one detectable element, wherein said at least one reference parameter is formed by the at least one detectable element.

This provides cheap and simple way of detecting the positions of various reference parameters on the second surface of the moulding element. No need for a laser-based system or large heavy arches. The positions are simply detected by moving the detection device along the second surface, wherein the sensors on the detection device are able to interact with the detectable element via a magnetic field. This significantly reduces the amount of manual labour associated with aligning various items on the moulding elements.

The present method may be used during the moulding process of the moulding element. For example, reference lines indicative of the locations of the edges of the main laminates may be detected using the present detection system. The present method may also be used in a post-moulding process to align items on the moulding element. For example, reference lines indicative of the locations of webs and/or spacer elements may be detected using the present detection system.

According to one embodiment, the method further comprises the steps of:
marking at least one selected reference parameter on said second surface,
aligning at least one item with said at least one selected reference parameter, and
attaching said at least one item to the moulding element.

The detected positions of the reference parameter(s) may suitably be marked on the second surface. The positions may be marked manually using a pen, a spray or other suitable markers. Alternatively, the positions may be marked by the detection device as it is moved along the second surface. The operator is thus able to move freely around on the second surface without blocking the projected laser beams.

One or more items, such as guiding elements, webs or spacer elements, may then be aligned relative to the marked reference lines. The items may be attached to the moulding element, e.g. using an adhesive. The adhesive may be applied to said items and/or to the second surface before placement of the items.

According to one embodiment, said detection device is manually or semi-automatically moved relative to the second surface.

The present detection device may be moved manually along the second surface by the operator. The operator may then mark the positions of the selected reference parameters as he/she moved along the second surface. Alternatively, the detection device may be arranged on a moveable unit, e.g. a remote-controlled unit, which is controlled by the operator. This allows the reference parameters to be detected and/or marked in a semi-automated process.

According to one embodiment, said at least one selected reference parameter is marked using a template of the detection device.

The marking may be performed using a template, e.g. a template comprising individual marking means (e.g. holes) arranged at different distances from the detection device. The marking means may be shaped to indicate a reference line, a reference point, a mounting point or other reference parameters. Therefore, allowing the reference parameters to be marked accurately relative to each other.

The detection device may be moved along one row of detectable elements, e.g. a main reference line, while the template of the detection device may be used to mark various reference parameters along the length of the second surface.

According to one embodiment, the method further comprises the step of:
determining the position of the detection device relative to the at least one detectable element, e.g. by use of an arrangement of sensors in the detection device, or by a unique shape of said at least one detectable element.

The positions of the detectable elements and thus the reference parameters may be detected using a sensor arrangement, wherein the operator is able to use the display unit to correctly align the detection device relative to the detectable element. An alignment window or an arrangement of diodes may be used by the operator to visually move the detection device into alignment.

According to one embodiment, a number of selected reference parameters are marked at the same time using the detection device.

The detection device may be used to detect and/or mark multiple reference parameters at the same time. For example, the detection device may be used to detect at least one first reference parameter, e.g. a centreline, and mark at least one second reference parameter, e.g. a web location line and/or a mounting point, at the same time. The first reference parameters may be equal to the second reference parameters, or have some overlap, or completely differ. The operator may use the template to mark the individual reference parameters. This saves time during production as the reference parameters can be marked in a fast and simple way.

### DESCRIPTION OF DRAWINGS

The invention is explained in detail below with reference to embodiments shown in the drawings, in which

FIG. 1 shows a wind turbine,

FIG. 2 shows an exemplary embodiment of the wind turbine blade,

FIG. 3 shows an exemplary embodiment of the detection system,

FIG. 4 shows an alternative embodiment of the detection device,

FIG. 5 shows a cross-sectional view of the detection system of FIG. 3 with a moulding element arranged on the support structure,

FIG. 6 shows an exemplary embodiment of the detection device with a template,

FIG. 7a-b show the detection device in alignment with detectable element and out of alignment,

FIG. 8 shows an exemplary embodiment of a holding element with adjustable means for adjusting the position of the detectable element,

FIG. 9a-b show two alternative positions of the detection device in relation to the detectable element,

FIG. 10 shows the detection device with exemplary embodiments of the template and examples of the reference parameter, and

FIG. 11 shows the detection device with a sensor arrangement and a control unit and a display unit.

### LIST OF REFERENCES

1. Wind turbine

2. Wind turbine tower

3. Nacelle

4. Hub

5. Wind turbine blades

6. Pitch bearing

7. Blade root

8. Tip end

9. Leading edge

10. Trailing edge

11. Blade shell

12. Pressure side

13. Suction side

14. Blade root portion

15. Aerodynamic blade portion

16. Transition portion

17. Length of wind turbine blade

18. Chord length of wind turbine blade

19. Root end structure

20. Detection system

21. Support structure

22. Supporting frame body

23. Contacting body part

24. Contact surface

25. Bottom surface

26. First edge

27. Second edge

28. First end

29. Second end

30. Detectable element

31. Detection device

32. Moulding element

33. First surface

34. Second surface

35. Template

36. Display unit

37. Alignment window

38. Profile of detectable element

39. Holding element

40. Adjustable means

41a-c, d. Reference lines

41e. Reference point, mounting point

42. Sensor arrangement

The listed reference numbers are shown in abovementioned drawings where no all reference numbers are shown on the same figure for illustrative purposes. The same part or position seen in the drawings will be numbered with the same reference number in different figures.

### DETAILED DESCRIPTION OF THE DRAWINGS

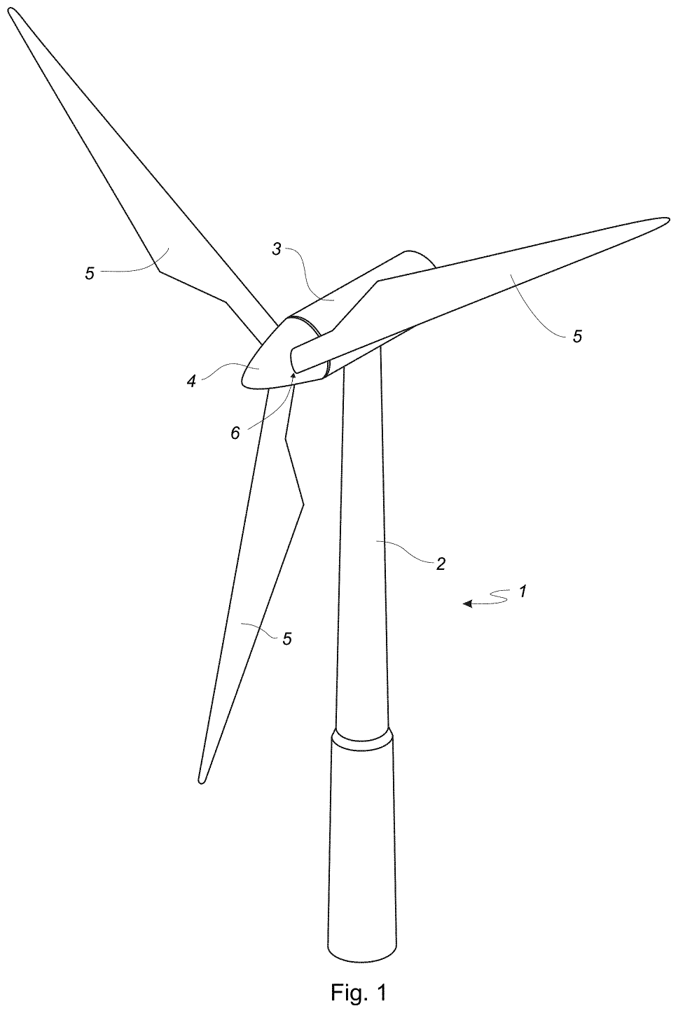

FIG. 1 shows a modern wind turbine 1 comprising a wind turbine tower 2, a nacelle 3 arranged on top of the wind turbine tower 2, and a rotor defining a rotor plane. The nacelle 3 is connected to the wind turbine tower 2, e.g. via a yaw bearing unit. The rotor comprises a hub 4 and a number of wind turbine blades 5. Here three wind turbine blades are shown, but the number of blades may be greater or smaller. The hub 4 is connected to a drive train located in the wind turbine 1 via a rotation shaft.

The hub 4 comprises a mounting interface for each wind turbine blade 5. A pitch bearing unit 6 is optionally connected to this mounting interface and further to a blade root of the wind turbine blade 5.

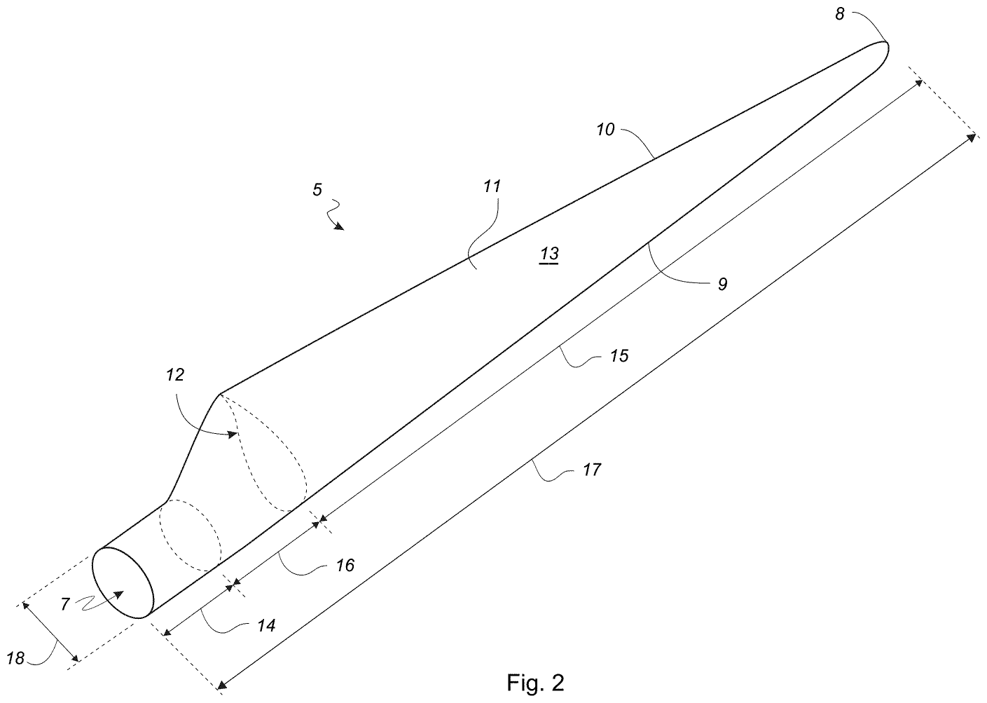

FIG. 2 shows a schematic view of the wind turbine blade 5 which extends in a longitudinal direction from a blade root 7 to a tip end 8. The wind turbine blade 5 further extends in a chordwise direction from a leading edge 9 to a trailing edge 10. The wind turbine blade 5 comprises a blade shell 11 having two opposite facing side surfaces defining a pressure side 12 and a suction side 13 respectively. The blade shell 11 further defines a root portion 14, an aerodynamic portion 15, and a transition portion 16 between the root portion 14 and the aerodynamic portion 15.

The root portion 14 has a substantially circular or elliptical cross-section (indicated by dashed lines). The root portion 14 together with a load carrying structure (not shown) are configured to add structural strength to the wind turbine blade 5 and transfer the dynamic loads to the hub 4. The load carrying structure extends between the pressure side 12 and the suction side 13 and further in the longitudinal direction.

The aerodynamic blade portion 15 has an aerodynamically shaped cross-section (indicated by dashed lines) designed to generate lift. The cross-sectional profile of the blade shell 11 gradually transforms from the circular or elliptical profile into the aerodynamic profile in the transition portion 16.

The wind turbine blade 5 has a longitudinal length 17 of at least 35 metres, preferably at least 50 metres. The wind turbine blade 5 further has a chord length 18 as function of the length 17, wherein the maximum chord length is found at the shoulder between the aerodynamic portion 15 and the transition portion 16. The wind turbine blade 5 further has a blade thickness as function of the chord length 18, wherein the blade thickness is measured between the pressure side 12 and the suction side 13.

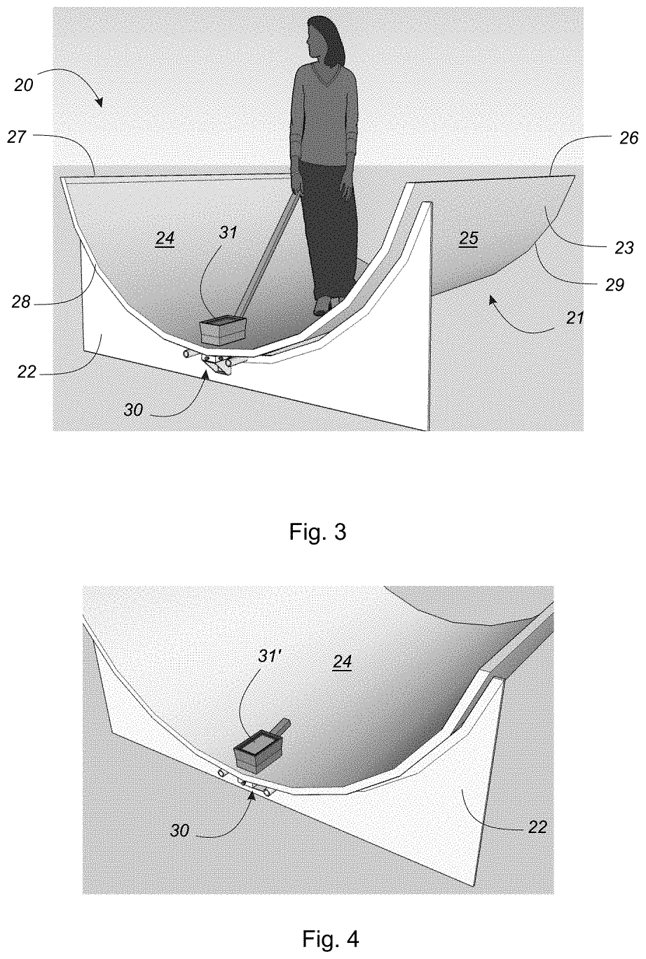

FIG. 3 shows an exemplary embodiment of a detection system 20 according to the invention, wherein the detection system 20 comprises a support structure 21. Here, the support structure 21 is a blade mould or a cradle. The support structure 21 has a frame body 22 for supporting a contacting body part 23. The body part 23 has a contact surface 24 and an opposite bottom surface 25. The contact surface 24 extends from a first edge 26 to a second edge 27 in a chordwise direction and further from a first end 28 to a second end 29 in a longitudinal direction.

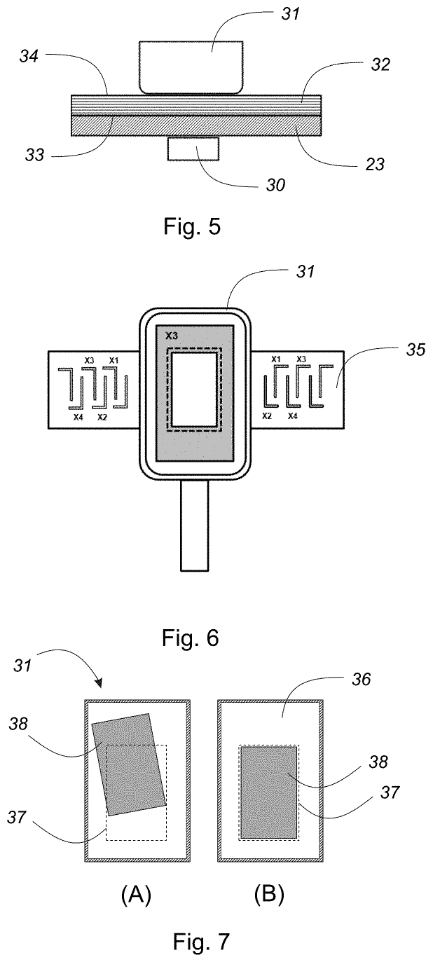

A number of detectable element 30, here only one is shown, is arranged relative to the contact surface 24. Each detectable element 30 is placed at a predetermined position to form one or more reference parameters of a moulding element (see FIG. 5). The detectable element is configured to interact with a detection device 31 via a magnetic field.

FIG. 4 shows an alternative embodiment of the detection device where the detection device 31′ is configured as a handheld scanner. In FIG. 3, the detection device 31 is provided on a hockey stick. The detection device 31, 31′ is able to be moved along a second surface, such as an inner surface, of the moulding element in order to detect the detectable elements 30.

FIG. 5 shows a cross-sectional view of the detection system 20 with the moulding element 32 arranged on the contacting body part 23. Here, the moulding element 32 is a composite structure comprising a fibre material. The moulding element has a first surface 33 facing the contact surface 24 and a second surface 34, i.e. inner surface.

Here, the detectable element 30 is a permanent magnet generating a magnetic field, where the local magnetic field lines extends through at least the contacting body part 23 and the moulding element 32. The detection device 31 has sensors (see FIG. 11) configured to detect this magnetic field which then can be used to align the detection device 31 relative to the detectable element 30.

FIG. 6 shows an exemplary embodiment of the detection device 31 with a template 35 for marking a number of reference parameters. The template 35 extends in opposite directions out from the detection device 31. The template 35 comprises individual marking means X1, X2, X3, X4 for marking a selected reference parameter. Here, the marking means X1, X2, X3, X4 are shaped as L-shaped holes so that the operator is able to manually mark the selected reference parameter.

Once the detectable element 30 is detected by the detection device 31, the detection device 31 is aligned with the detectable element 30. FIG. 7a shows the detection device out of alignment with the detectable element 30.

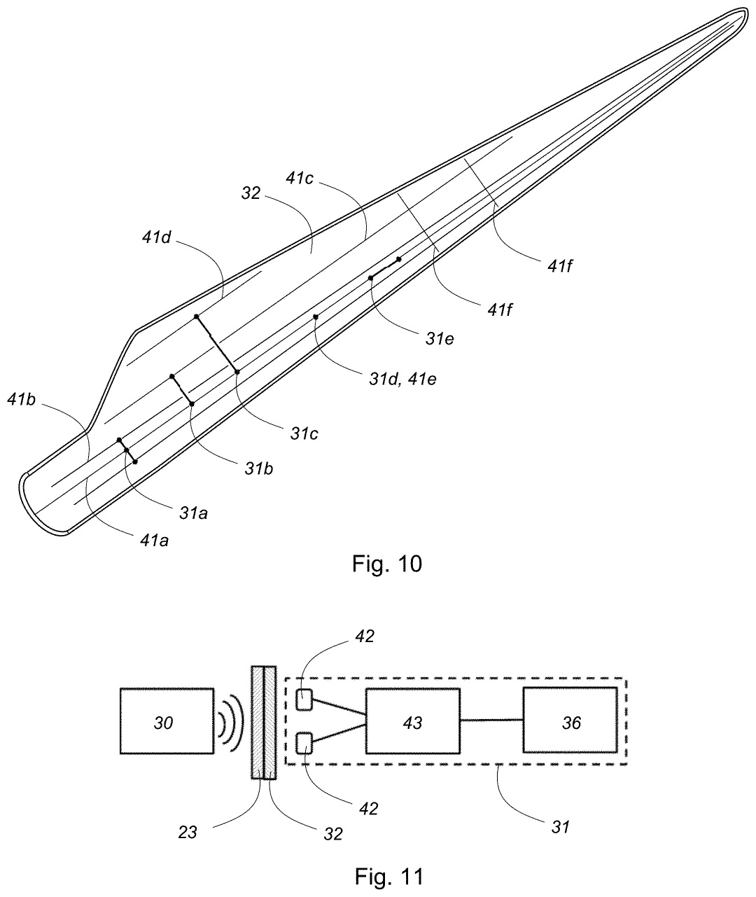

Here, the detection device 31 has a display unit 36 on which an alignment window 37 is displayed. Further, a control unit (see FIG. 10) of the detection device 31 is configured to generate a detected profile 38 of the detectable element 30, as illustrated in FIG. 7a. The profile 38 and the alignment window 37 is used to visually align the detection device 31 relative to the detectable element 30, as illustrated in FIG. 7b.

When the detection device 31 is aligned, the selected reference parameters may be marked, e.g. using the template 35.

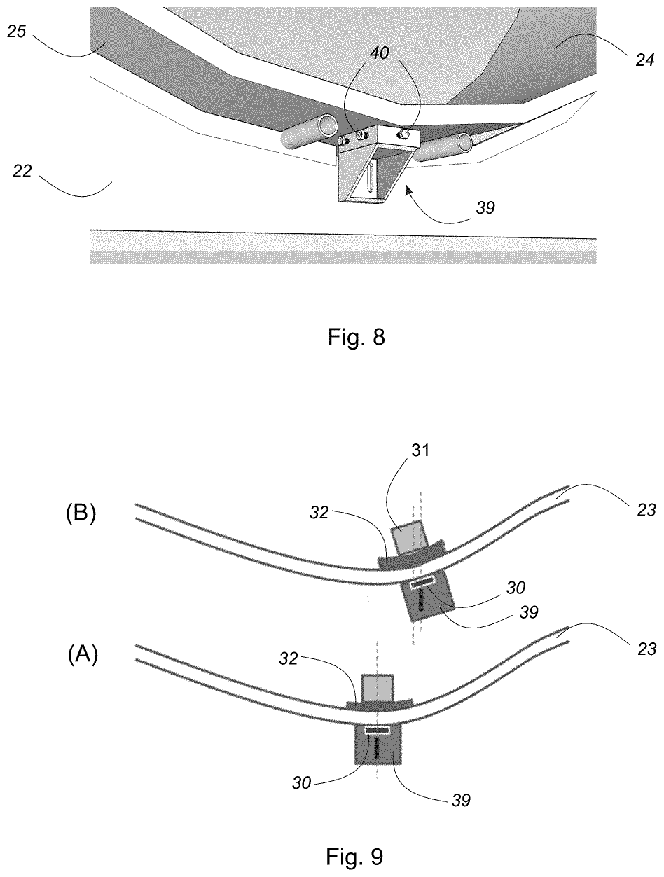

FIG. 8 shows an exemplary embodiment of a holding element 39 with adjustable means 40 for adjusting the position of the detectable element 30. The holding element 39 is configured to hold the detectable element 30 in a predetermined position. The holding element 39 is further configured to be connected to the frame body 22. Here, the holding element 39 is arranged at the bottom surface 25.

The holding element 39 comprises adjustable means 40 for adjusting the position of the detectable element 30 in the longitudinal direction and/or in the chordwise direction. The adjustable means 40 are here formed as adjustable bolts connected to the detectable element 30.

FIG. 9 shows two alternative positions of the detection device 31 in relation to the detectable element 30. The adjustable means 40 are here used to compensate for the curvature of the moulding element 32 and the body part 23 so that the position of the reference parameter is correctly detected on the second surface 34.

When the curvature is close to zero, as illustrated in FIG. 9a, the detection device 31 is placed more or less above the detectable element 30 and thus no or a minor correction is needed.

As the curvature is increases, as illustrated in FIG. 9b, the detection device 31 is offset relative to the detectable element 30 and thus a correction is needed.

FIG. 10 shows an exemplary embodiment of the moulding element 32. Here, the moulding element 32 is a composite structure of a wind turbine blade, e.g. a blade shell part. Further, various embodiments of the detection device 31 and the reference parameter are shown here.

The detection device 31a, 31b, 31c, 31d is configured to detect the position of at least one reference parameter, e.g. a centreline 41a, on the second surface 34 of the moulding element 32 in relation to one or more detectable elements 30.

The detection device 31a may be fitted with a template for marking a first and a second reference line. The distance between the first and second reference lines may decrease towards the second end 29, as illustrated, or be constant. Here, the first and second reference lines indicate the web location lines 41b of the main shear webs.

The detection device 31b may be fitted with a template for marking a third reference line. Here, the third reference line indicates the web location line 41c of a third main shear web.

The detection device 31c may be fitted with a template for marking a fourth reference line. Here, the fourth reference line indicates the web location line 41c of a reinforcing web. The third reference line and/or fourth reference line may be located towards the first edge 26 or the second edge 27.

The detection device 31d may be configured to detect a first reference parameter, e.g. the centreline 41a, and mark the first reference parameter and/or a second reference parameter, e.g. a mounting point 41e.

The detection device 31e may be configured to detect at least two detectable elements 30 forms part of the same reference parameter, e.g. the centreline 41a.

Here, each reference line 41a-d and the corresponding detectable elements 30 extends parallel to the longitudinal direction. However, the detection device 31 may also be used to detect detectable elements 30 and mark reference lines extending in the chordwise direction. These reference lines may indicate the location lines 41f of local spacer elements or bulkheads.

FIG. 11 shows the detection device 31 with a sensor arrangement 42 for detecting the magnetic field of the detectable elements 30. The sensor arrangement 42 is electrically connected to a control unit 43 configured to process and analyse the respective sensor signals. The control unit 43 is further electrically connected to the display unit 36. The control unit 43 may generate a detected profile of the detectable element 30 based on the sensor signals, wherein this detected profile is displayed on the display unit 36. This enables to the operator to align the detection device 31 correctly relative to the detectable element 30.

The abovementioned embodiments may be combined in any combinations without deviating from the present invention.

1. A detection system for detecting a reference parameter of a moulding element, such as a composite structure, the detection system comprising a support structure configured to hold the moulding element, the support structure having a contact surface shaped to contact a first surface of the moulding element, the detection system comprising at least one detectable element arranged relative to the contact surface, the at least one detectable element being configured to interact with at least one detection device via a magnetic field characterised in that said at least one detectable element forms at least one reference parameter of said moulding element, and that said at least one detection device is configured to be moved along said contact surface and to detect a position of said at least one reference parameter on a second surface of the moulding element in relation to said at least one detectable element.

2. The detection system according to claim 1, characterised in that said at least one reference parameter is a reference line, a reference point and/or a mounting point.

3. The detection system according to claim 1, characterised in that a first number of detectable elements are distributed along the contact surface to form a first reference line, and at least a second number of detectable elements are further distributed along the contact surface to form at least a second reference line, the second reference line being arranged at a distance from said first reference line.

4. The detection system according to claim 1, characterised in that said at least one detectable element is integrated into the support structure.

5. The detection system according to claim 1, characterised in that the least one detectable element is arranged on a holding element, the holding element being configured to be connected to the support structure.

6. The detection system according to claim 5, characterised in that said holding element comprises adjustable means for adjusting the position of that detectable element in the chordwise direction and/or in the longitudinal direction.

7. The detection system according to claim 1, characterised in that said at least one detection device further comprises alignment means for aligning the at least one detection device relative to the position of the at least one detectable element.

8. The detection system according to claim 1, characterised in that said at least one detection device further comprises a template extending from the detection device, wherein said template comprises means for marking at least one selected reference parameter.

9. The detection system according to claim 7, characterised in that said at least one detection device comprises an arrangement of sensors configured to detect said at least one detectable element, the sensors being connected to a control unit and/or a display unit for determining the position of the at least one detection device in relation to the at least one detectable element.

10. The detection system according to claim 1, characterised in that said at least one detectable element is a permanent magnet, an electromagnet or a magnetisable element.

11. The detection system according to claim 1, characterised in that said moulding element is a composite structure of a wind turbine blade, and said support structure is a mould for moulding said composite structure or a cradle for holding said composite structure.

12. A detection device of a detection system, the detection system comprises a support structure configured to hold a moulding element having a composite structure, such as a wind turbine blade or wind turbine blade shell part, the support structure having a contact surface shaped to contact a first surface of the moulding element, the moulding element further having a second surface opposite of said first surface, the detection system further having at least one detectable element arranged relative to said contact surface and configured to interact with the detection device via a magnetic field, wherein said detection device is configured to be moved along said contact surface and to detect a position of at least one reference parameter on the second surface in relation to said at least one detectable element, the at least one reference parameter being formed by said at least one detectable element.

13. A method of detecting a reference line of a moulding element, the method comprises the steps of:
providing a support structure configured to hold the moulding element, the support structure having a contact surface shaped to contact a first surface of the moulding element, the support structure comprising at least one detectable element arranged relative to the contact surface and configured to interact with a detection device via a magnetic field,
providing the moulding element having a composite structure, such as a wind turbine blade or wind turbine blade shell part, the moulding element further has a second surface opposite of said first surface, and
moving the detection device along said second surface to detect a position of at least one reference parameter on the second surface in relation to said at least one detectable element, wherein said at least one reference parameter is formed by the at least one detectable element.

14. The method according to claim 13, characterised in that the method further comprises the steps of:
marking at least one selected reference parameter on said second surface,
aligning at least one item with said at least one selected reference parameter, and
attaching said at least one item to the moulding element.

15. The method according to claim 13, characterised in that said detection device is manually or semi-automatically moved relative to the second surface.

16. The method according to claim 13, characterised in that said at least one selected reference parameter is marked using a template of the detection device.

17. The method according to claim 13, characterised in that the method further comprises the step of:
determining the position of the detection device relative to the at least one detectable element, e.g. by use of an arrangement of sensors in the detection device, or by a unique shape of said at least one detectable element.

18. The method according to claim 14, characterised in that a number of selected reference parameters are marked at the same time using the detection device.
